(19) United States
(12) Patent Application Publication
(10) Pub. No.: US 2005/0083189 A1
(43) Pub. Date: Apr. 21, 2005

(54) Engine speed sound-warning device

(76) Inventor: Ching-Hung Wang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/684,479

(22) Filed: Oct. 15, 2003

(51) Int. Cl. B60Q 1/00

(52) U.S. Cl. 340/441

(57) ABSTRACT

An engine speed sound-warning device includes a central processor that receives a detection signal of engine revolution, and compares the received signal with an engine speed value preset via a setting selection unit. When the detected signal of engine speed exceeds the preset engine speed value, a sound is emitted under control to notify and warn the driver.

### FIELD OF THE INVENTION

The present invention relates to an engine speed sound-warning device, and more particularly to a warning device that detects an engine revolution and emits warning sound when the detected engine revolution exceeds a preset value.

### BACKGROUND OF THE INVENTION

An automobile moves when its wheels are driven by an engine to rotate. Engine revolution is an important value for control the speed and output horsepower of the automobile. When the engine revolution is low, the automobile is normally at low moving speed, and when the engine revolution is high, the automobile is normally at high moving sped. When the engine revolution is very high and the automobile fails to increase its moving speed or its hill-climbing force or torsion force, it is apparent the automobile has some problem with it. Or, when the engine revolution has been kept at high for a prolonged time, the engine would produce a large amount of heat to have detriment to the automobile.

Generally, an automobile is equipped with an engine revolution counter to show the engine revolution of the moving automobile at every moment. However, most drivers do not notice the engine speed during driving and fail to find any problem with the automobile at an early stage, resulting in serious damage to the automobile or even fatal accident. It is therefore tried by the inventor to develop a warning device that emits sound when the engine speed is too high.

### SUMMARY OF THE INVENTION

A primary object of the present invention is to provide an engine speed sound-warning device that emits warning sound when the engine speed of a moving automobile is too high, so that the driver is notified of any possible problem with the automobile at an early stage to avoid undesired accidents.

To achieve the above object, the present invention mainly includes a central processor that receives a detection signal of engine revolution, and compares the received signal with an engine speed value preset via a setting selection unit. When the detected signal of engine speed exceeds the preset engine speed value, a sound is emitted under control to notify and warn the driver.

Another object of the present invention is to provide an engine speed sound-warning device that includes a setting selection unit for a driver to set the time of emitting warning sound according to the type of automobile and actual need in driving.

A further object of the present invention is to provide an engine speed sound-warning device that is able to emulate the sound produced by a racing car at high engine speed, so as to satisfy the driver's imagination of road racing.

### BRIEF DESCRIPTION OF THE DRAWINGS

The structure and the technical means adopted by the present invention to achieve the above and other objects can be best understood by referring to the following detailed description of the preferred embodiments and the accompanying drawing, wherein

FIG. 1 is a block diagram of the present invention.

### DETAILED DESCRIPTION OF THE PREFERRED EMBODIMENTS

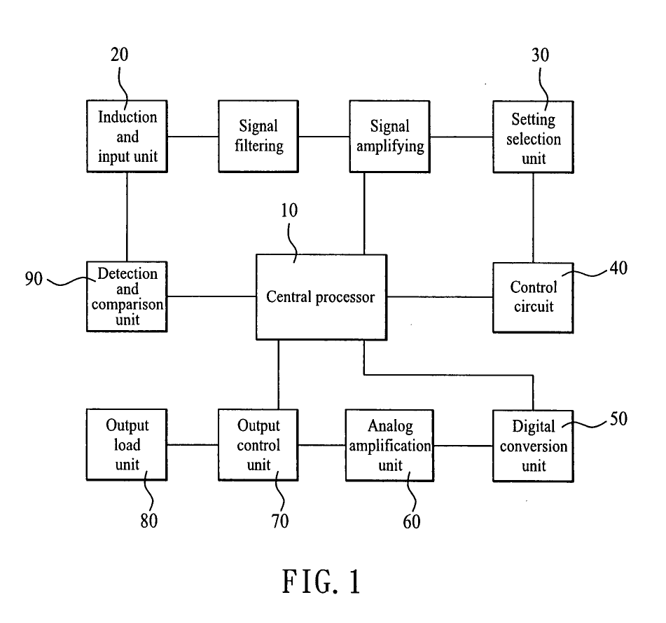

Please refer to FIG. 1 that is a block diagram of a circuit structure of an engine speed sound-warning device of the present invention. As shown, the circuit structure of the present invention mainly includes a central processor 10 adapted to receive a signal from an engine speed induction and input unit 20. The signal is verified as a correct signal by a detection and comparison unit 90, filtered, and amplified, and then sent to the central processor 10.

A setting selection unit 30 provides a value input interface, via which a user inputs a preset value, which is then input to the central processor 10 via a control circuit 40 to serve as a comparative value.

When the signal obtained at the induction and input unit 20 is sent to the central processor 10, the central processor 10 would compare it with the comparative value previously entered via the setting selection unit 30. When the detected engine speed is larger than the preset value, the central processor 10 outputs a signal that is converted by a digital conversion unit 50 and amplified by an analog amplification unit 60, and output by an output control unit 70 for an output load unit 80 to emit a warning sound.

In the present invention, the output load unit 80 may be a sound-producing device that is able to emit a warning sound to remind a driver that the engine speed has exceeded the preset value, so that the driver may take necessary action as soon as possible to drive safely.

It is possible for the sound-producing device to emulate the sound produced by a racing car at high engine speed, so that the sound emitted from the sound-producing device not only serves to warn the driver but also satisfies the driver's imagination of road racing.

In brief, the present invention provides an engine speed sound-warning device that may from time to time remind the driver that the automobile is running at a very high engine speed, so that the driver may drive safely.

1. An engine speed sound-warning device, comprising:
a central processor;
an induction and input unit for obtaining a value of engine speed, and sending said obtained value of engine speed to said central processor;
a setting selection unit including an input interface, via which a selected value is input to said central processor; and
an output load unit adapted to emit a warning sound;
wherein said central processor receives said value of engine speed sent from said induction and input unit, and compares said received value of engine speed with said selected value input via said setting selection unit; and said central processor emits a signal when said received value of engine speed is larger than said selected value, so as to cause said output load unit to emit the warning sound.

2. The engine speed sound-warning device as claimed in claim 1, wherein said output load unit emits a warning sound that emulates a sound produced by a racing car at high engine speed.
